(19) United States
(12) Patent Application Publication
(10) Pub. No.: US 2026/0007275 A1
(43) Pub. Date: Jan. 8, 2026

(54) WATER-OIL SEPARATION TYPE FRYING DEVICE

(71) Applicants: Ki Jong SHIN, Orem, UT (US); Young Ho Brigham SHIN, Orem, UT (US); Keun Ho Joseph SHIN, Orem, UT (US); Jin Ho David SHIN, Orem, UT (US); Ka Hee Lilia SHIN, Orem, UT (US)

(72) Inventor: Ki Jong SHIN, Orem, UT (US)

(21) Appl. No.: 18/762,159

(22) Filed: Jul. 2, 2024

(51) Int. Cl. A47J 37/12

(52) U.S. Cl. CPC A47J 37/1223; A47J 37/1219; A47J 37/1261; A47J 37/1266

(57) ABSTRACT

A water-oil separation type frying device includes: a frame; a frying portion installed on the frame; a circulation portion configured to circulate water filled in a lower portion of the frying portion; a filter portion installed at a predetermined position of the circulation portion to remove foreign substances from the water circulated along the circulation portion; a control portion configured to control the frying portion and the circulation portion; and a lifting mechanism including a frying plate accommodated in the frying portion so that food that needs to be fried is placed on the frying plate during frying, and a mechanism for lifting up and down the frying plate.

### BACKGROUND OF THE INVENTION

### 1. Field of the Invention

The present invention relates to a water-oil separation type frying device, and more specifically, to a water-oil separation type frying device which prevents a waste of cooking oil and effectively fries food by using oil-water separation due to a difference in a specific gravity of the cooking oil and water to facilitate removal of scraps generated from frying so that discoloration of the food and deterioration of the cooking oil are minimized, which prevents smoke and odor, which are generated during frying as animal fat and food scraps are mixed with the cooking oil and the mixture thereof is burned, from damaging the lungs, and which prevents generation of toxic substances in the cooking oil to minimize the risk of adult diseases and various cancers.

### 2. Description of the Related Art

The water-oil separation type frying device literally refers to a device that makes various types of frying by pouring oil onto water. Unlike a typical frying device in which oil splashes all over when water is poured during boiling of the cooking oil, in the case of the water-oil separation type frying device, when water is poured, the water precipitates downward as it is, and oil is not splashed.

Although the water-oil separation type frying device is relatively expensive compared to general frying units, it can be seen that the water-oil separation type frying device is not expensive at all when comparing the product development cost and the saved amount of cooking oil, electricity, and gas. The advantages of the water-oil separation type frying device are reduction in cooking oil consumption and extension of a lifespan of the water-oil separation type frying device (about 50% reduction) because water is present under the cooking oil so that powder, chicken fat, odor, and the like are absorbed into water, thereby maintaining clear cooking oil for a long time as compared to the existing frying device in which acidification of the cooking oil is accelerated when chicken is fried at high temperature of 170° C. or higher together with chicken fat, powder, odor generated from the chicken, and the like.

This cost reduction may be saved by about 250 US dollars per month by reducing about 9.5 to 11 gallons of cooking oil when about 24 gallons of cooking oil is used.

In addition, electricity and gas costs decrease. In general, ordinary electric and gas frying devices take about 20 minutes to raise the temperature of cooking oil to about 170° C. for the first time, and the heat loss thereof is so large that a user cannot touch an upper exhaust port due to its high temperature. In addition, when a frying operation is not performed, the cooking oil needs to be maintained at around 120° C. to 130° C., so that electricity and gas are always used.

However, the water-oil separation type frying device takes only about 8 minutes to raise the temperature to 170° C., and the heat efficiency thereof is very high because the exhaust port does not emit much heat. This is because the heat efficiency is increased by using a patented burner called a proportional control combustion method rather than a natural combustion method. Thus, using the water-oil separation type frying device may reduce electricity and gas costs by about 30% to 40%. If monthly electricity and gas costs are 300 US dollars, the electricity and gas costs may be saved up to 80 US dollars to 115 US dollars. In addition, an air conditioner is useless because of the heat generated from the exhaust port of an ordinary frying devices. However, when the frying operation is performed using the water-oil separation type frying device, the stress from the heat and the consumption of electricity and gas are reduced due to the low heat from its exhaust port.

In addition, there is no odor even if chickens are fried for a long time. Chickens have unique odor. When cooking the unique odor is covered with various spices (pepper, etc.), but it is inevitable that the unique odor is dissolved in oil when frying. In the case of the water-oil separation type frying device, the odor is dissolved in water, so that when water is changed frequently, oil may be used for a longer time, and there is little odor in fried food.

In particular, the fried food may become crispy. In order to make the fried food crispy, the temperature needs to be raised, but in general frying devices, raising of the temperature inevitably shortens the lifespan of cooking oil. In this regard, the water-oil separation type frying device contains a lot of moisture in the cooking oil, so that the food may be fried more crisply.

Obviously, the water-oil separation type frying device has a disadvantage of the high price, but is not expensive at all because it saves more than 250 US dollars in cooking oil and gas per month.

In order to maximize the advantages of the water-oil separation type frying device, filtration and discharge of impurities need to be effectively performed. A conventional water-oil separation type frying device has excellent impurity filtering and discharging effects, but in order to maximize the advantages of the water-oil separation type frying device, a more efficient impurity filtering and discharging technology is required.

### RELATED ART DOCUMENT

Korean Unexamined Patent Publication No. 10-2023-0153685 (Published on Nov. 7, 2023)

### SUMMARY OF THE INVENTION

The present invention is to provide a water-oil separation type frying device which is provided with a structure and a unit capable of further maximizing the effective filtration and discharge of impurities of the conventional water-oil separation type frying device, so that the impurities are effectively and the impurities are frequently and smoothly filtered, discharged as compared to the related art, thereby obtaining sanitation and excellent efficiency.

Further, the present invention is to provide a water-oil separation type frying device in which a control portion having a timer and a lifting mechanism are provided, so that fried food may automatically float out of oil when a certain period of time has elapsed, thereby preventing a conventional phenomenon of overcooking due to the food being placed in the oil even after a frying time has elapsed.

A water-oil separation type frying device according to the present invention includes: a frame; a frying portion installed on the frame; a circulation portion configured to circulate water filled in a lower portion of the frying portion; a filter portion installed at a predetermined position of the circulation portion to remove foreign substances from the water circulated along the circulation portion; a control portion configured to control the frying portion and the circulation portion; and a lifting mechanism including a frying plate accommodated in the frying portion so that food that needs to be fried is placed on the frying plate during frying, and a mechanism for lifting up and down the frying plate.

The mechanism for lifting up and down may include a lifting control motor configured to drive the frying plate such that the frying plate is lifted up and down, a power transmission tool configured to transmit a driving force of the lifting control motor to the frying plate, a guide rail configured to guide the frying plate such that the frying plate is lifted up and down with respect to the power transmission mechanism, a lifting control panel for controlling the lifting control motor.

In addition, a power switch, which is provided in the control portion so as to turn on or off power of the control portion, may be installed on a front surface of the frame.

As described above, the control portion having a timer and the lifting mechanism are provided, so that fried food may automatically float out of oil when a certain period of time has elapsed, thereby preventing a conventional phenomenon of overcooking due to the food being positioned in the oil even after a frying time has elapsed.

Preferably, the frying portion may include a frying tank configured to accommodate water and oil and having a drain hole formed in a lower portion thereof, a heating unit configured to transmit thermal energy to an inside of the frying tank; and a heating module configured to control the heating unit to generate the thermal energy,

The heating unit may include a heating wire configured to emit the thermal energy, and the heating unit may be preferably filled with a heating electric coil or a heating gas.

The control portion may be provided with a control panel for an operation, the control panel may be preferably provided on a side surface of the frame and may be spaced apart from the frying portion, thereby preventing a short circuit caused by the water accommodated in the frying portion.

The circulation portion may preferably include a discharge pipe connected to the drain hole to serve as a path for discharging the water in the lower portion of the frying tank, and a circulation pipe which is a path for connecting the discharge pipe and the frying tank so as to supply the water back to the lower portion of the frying tank in a state where the foreign substances are removed from the water discharged along the discharge pipe.

The filter portion may include a filter case, a filter detachably accommodated in the filter and a support installed under the filter case, the discharge pipe may be installed above a location of the filter in the filter case, and the circulation pipe is installed below the location of the filter in the filter case, water containing scraps discharged from the frying tank may enter an inside of the filter case along the discharge pipe so that the scraps are filtered out while passing through the filter, and the water may flow out along the circulation pipe and may be supplied back to the frying tank.

The filter case may have a separate sewage pipe installed at a lower portion of the location of the filter, the filter case may be provided at an upper portion thereof with a filter cover, in which the filter cover includes two plate members which are slidably coupled to each other while facing each other side by side at the upper portion of the filter case, thereby sealing the upper portion of the filter case, semicircular grooves may be formed at contact points between the two plate members, respectively, so that a circular hole may be formed when the semicircular grooves meet each other and the discharge pipe may be inserted into the circular hole, so that the filter portion may be continuously usable without replacement of the filter portion by replacing only the filter after the filter cover is opened.

The filter may have a concavo-convex portion formed on a surface thereof, and the concavo-convex portion may preferably have a shape in which a main filtration zone having a center protruding upward, side filtration zones protruding upward from both sides of the concavo-convex portion, and impurity zones recessed between the main filtration zone and the side filtration zone are continuously formed.

The main filtration zone may preferably have a shape in which a peak is formed at the center thereof, a slope is formed downward in every direction from the peak such that a horizontal cross-sectional area increases, and the slope may be configured such that the horizontal cross-sectional area decreases at a predetermined point, so that a volume of the impurity zone may be secured to accumulate a large amount of impurities, and a filter surface area for enabling filtration may be sufficiently secured at an upper portion of the main filtration zone.

The water-oil separation type frying device according to the present invention is provided with a structure and a unit capable of further maximizing the effective filtration and discharge of impurities of the conventional water-oil separation type frying device, so that the impurities may be effectively filtered and may be frequently and smoothly discharged as compared to the related art, and thus the water-oil separation type frying device obtains sanitation and minimizes environmental pollution, thereby obtaining excellent effect of improving efficiency.

In addition, the water-oil separation type frying device according to the present invention is provided with a control portion having a timer and a lifting mechanism are provided, so that fried food may automatically float out of oil when a certain period of time has elapsed, thereby preventing a conventional phenomenon of overcooking due to the food being positioned in the oil even after a frying time has elapsed.

### BRIEF DESCRIPTION OF THE DRAWINGS

FIG. 1 is a perspective view of a water-oil separation type frying device according to one embodiment of the present invention.

FIG. 2 is a side perspective view of the water-oil separation type frying device according to one embodiment of the present invention.

FIG. 3 is a side perspective view of a filter portion of the water-oil separation type frying device according to one embodiment of the present invention.

FIG. 4 is a side perspective view of the filter portion showing a modified example of FIG. 3.

### DETAILED DESCRIPTION OF THE INVENTION

Hereinafter, various embodiments of the present invention will be described by certain embodiments illustrated in the accompanying drawings. It should be understood that the differences between the embodiments are not mutually exclusive, and the specific shapes, structures, and characteristics described in connection with the embodiments may be implemented as other embodiments without departing from the technical spirit and scope of the present invention.

Hereinafter, the present invention will be described in detail with reference to the accompanying drawings.

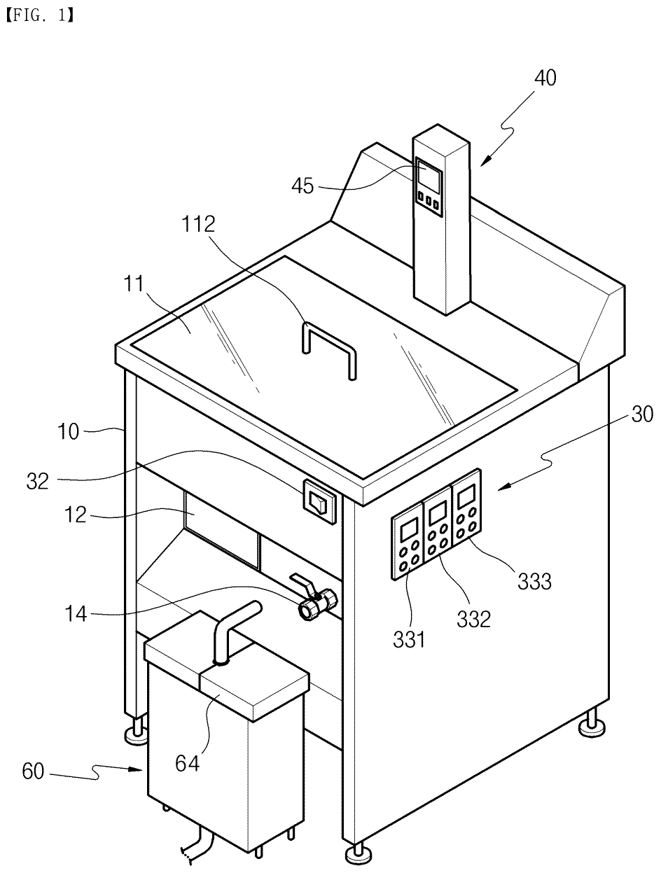

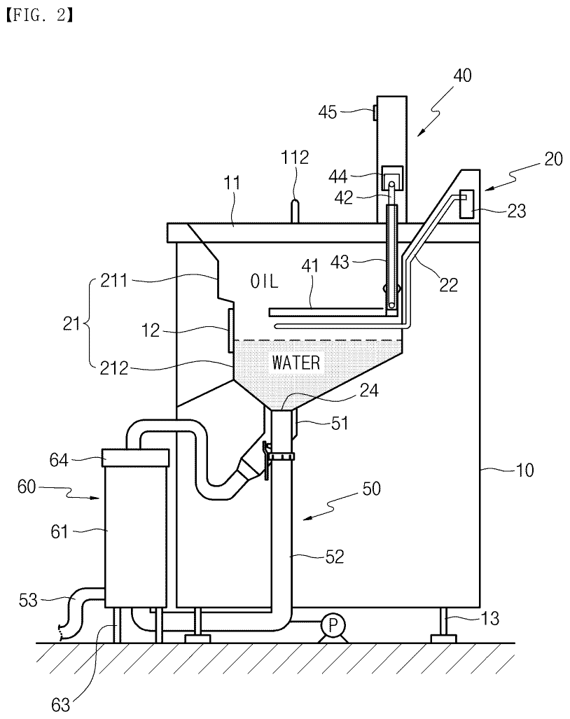

Referring to FIGS. 1 and 2, the water-oil separation type frying device according to one embodiment of the present invention includes a frame 10, a frying portion 20, a circulation portion 50, a filter portion, a control portion 30, and a lifting mechanism 40.

The frame 10 is not particularly limited in its shape as long as it has an internal volume sufficient to accommodate the frying portion 20, the control portion 30, and the lifting mechanism 40, which will be described later. Referring to FIG. 2, a support 13 capable of adjusting a height may be attached to the frame 10, but the support 13 is not necessarily required. The frying portion 20 is installed inside the frame 10, in which water and oil are introduced into the frying portion 20, and when thermal energy is applied, food materials to be fried, are dipped at a position where the oil is present, thereby performing frying.

The circulation portion 50 serves to circulate water filled in the lower portion of the frying portion 20. As will be described later, the circulation portion 50 removes impurities from the water filled in the lower portion of the frying portion 20, and then supplies purified water back to the frying portion 20.

The filter portion 60 is installed at a predetermined position of the circulation portion 50 and serves to remove foreign substances from the water circulating along the circulation portion 50.

The control portion 30 serves to turn on or off power to the frying portion 20, the circulation portion 50, and the lifting mechanism 40 to be described later, and serves to control a temperature of the oil, a temperature of the water, and a frying time.

Referring to FIG. 2, the lifting mechanism 40 includes a frying plate 41 accommodated in the frying portion 20 so that food that needs to be fried is placed on the frying plate 41 during frying, and a mechanism for lifting up and down the frying plate 41.

In this case, as illustrated in FIG. 2, the mechanism for lifting up and down may include a lifting control motor 44 for driving the frying plate 41 to be lifted up and down, a power transmission mechanism 42 which transmits a driving force of the lifting control motor 44 to the frying plate 41, a guide rail 43 which guides the frying plate 41 such that the frying plate 41 is lifted up and down with respect to the power transmission mechanism 42, and a lifting control plate 45 for controlling the lifting control motor 44.

If the lifting mechanism 40 is not provided, although the frying process may be automatically controlled, the fried food needs to be manually taken out. This is because even if the heating is stopped, the oil is kept at a high temperature for a considerable period of time, so that the food may be over-fried, resulting in change of the taste or deterioration in the texture.

On the other hand, in the water-oil separation type frying device according to one embodiment of the present invention, the lifting mechanism 40 is provided, so that when a predetermined cooking time has elapsed, the power transmission mechanism 42 transmits the power of the lifting control motor 44 to a side of the frying plate 41 by the frying plate 41 and the frying plate 41 is lifted up and down along the guide rail 43, so that the frying process may be terminated immediately as the finished fried food is exposed to the air, thereby maintaining the taste and the texture according to a planned time.

Therefore, the control portion having a timer and the mechanism are provided, so that fried food may lifting automatically float out of oil when a certain period of time has elapsed, thereby preventing a conventional phenomenon of overcooking due to the food being positioned in the oil even after the frying time has elapsed.

For reference, referring to FIGS. 1 and 2, the lifting mechanism 40 may be controlled by a user's operation at an eye level of the user by installing the lifting control panel 45 in a tower-shaped box.

As illustrated in FIG. 2, the frying portion 20 may include a frying tank 21 in which water and oil are accommodated and a drain hole is formed at a lower portion thereof, a heating unit 22 for transmitting thermal energy to an inside of the frying tank 21, and a heating module 23 for controlling the heating unit 22 to generate the thermal energy.

In addition, as illustrated in FIG. 1, a cover 11 may be provided on the frying tank 21 with a handle 112 so as to seal the upper portion of the frying tank 21 during a time other than a use time of the water-oil separation type frying device.

In this case, the heating unit 22 may include a heating wire (not shown) for emitting the thermal energy, in which the heating wire may be filled with a heating coil or heating gas (not shown). That is, a specific unit constituting the heating unit 22 may adopt a method of producing the thermal energy using electric energy or a method of producing the thermal energy using combustion of a gas.

Thus, the heating module 23 may be a device (not shown) for applying the power to the heating coil when the heating unit 22 is a heating coil type, or an ignition device (not shown) for heating a heating medium or burning the heating medium when the heating unit 22 is a tube filled with the heating medium.

The control portion 30 may be provided with a control panel 33 for an operation as illustrated in FIG. 1.

In particular, as illustrated in FIG. 1, the control panel 33 may be provided on a side surface of the frame 10 and may be separated from the frying portion 20, so that the water accommodated in the frying portion 20 may be scattered to a circuit connected to the control panel 33 or a power system (not shown), thereby preventing a short circuit caused by the scattering.

Specifically, as illustrated in FIG. 1, the control panel 33 may be classified into an oil temperature control panel 331, a water temperature control panel 332, and a timer control panel 333, so that distinction of the respective operation buttons may be clearly recognized, thereby preventing a user's confusion even in a dark indoor environment.

Further, a power switch 32, which is provided in the control portion 30 to turn on or off power of the control portion 30, may be installed on an upper front surface of the frame 10 as illustrated in FIG. 1, so that an operation of the power switch 32 may be conveniently performed.

The circulation portion 50 may include a discharge pipe 51 connected to a drain hole 24 to serve as a path for discharging the water in the lower portion of the frying tank 21, and a circulation pipe 52 which is a path for connecting the discharge pipe 51 and the frying tank 21 so as to supply the water back to the lower portion of the frying tank 21 in a state where the foreign substances are removed from the water discharged along the discharge pipe 21.

For reference, as illustrated in FIG. 2, an inside of the frying tank 21 may be divided into a space of a frying tank upper portion 211 mainly filled with oil and a space of a frying tank lower portion 212 mainly filled with water, and the discharge pipe 51 is connected to the drain hole 24 formed at the lowermost side of a space of the lower portion of the frying tank 21. Further, an observation plate 12 formed to monitor the inside of the frying tank 21 is installed between the frying tank upper portion 211 and the frying tank lower portion 212 to check the states of oil and water.

In this case, the filter portion 60 may be installed between the discharge pipe 51 and the circulation pipe 52 as illustrated in FIG. 2, so that scraps may be filtered out from water containing the scraps discharged through the discharge pipe 51 and the purified water may be supplied back to the frying tank 21.

For reference, as illustrated in FIG. 2, a pump is installed in the circulation pipe 52, so that the water may be smoothly circulated by the pump.

In addition, as illustrated in FIG. 1, the oil that is no longer usable may be discharged through an oil drain pipe 14 that is separately provided.

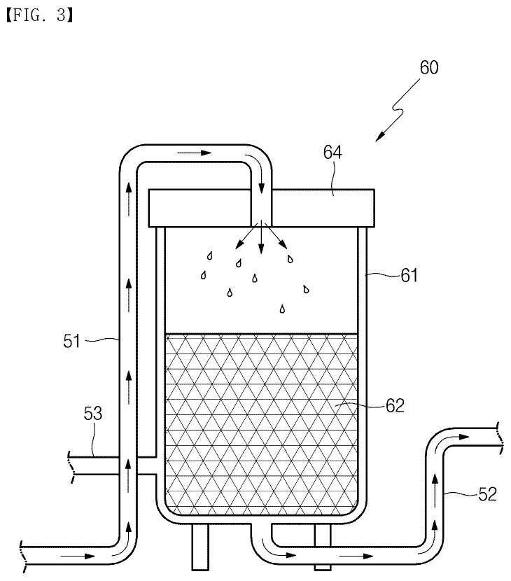

As illustrated in FIG. 3, the filter portion 60 may include a filter case 61, a filter 62 accommodated in the filter case 61, and a support 63 installed at a lower portion of the filter case 61.

The discharge pipe 51 may be installed above a location of the filter 62 in the filter case 61, and the circulation pipe 52 may be installed below the location of the filter 62 in the filter case 61, the water containing the scraps discharged from the frying tank 21 may enter an inside of the filter case 61 along the discharge pipe 51 so that the scraps may be filtered out while passing through the filter 62, and the water may flow out along the circulation pipe 52 and may be supplied back to the frying tank 21.

In this case, as illustrated in FIGS. 1 and 2, a separate drainpipe 53 may be installed at a lower portion of the location of the filter 62, and thus, when the frying is terminated and the water is not required, the water filtered by the filter 62 does not flow through the circulation pipe 52 and may be discarded along the drain pipe 53. In this case, the discarded water may be purified with the filter 62, thereby preventing environmental pollution.

Moreover, the filter case 61 may be installed at an upper portion thereof with a filter cover 64, and as can be inferred from FIG. 1, the filter cover 64 includes two plate members which are slidably coupled to each other while facing each other side by side at the upper portion of the filter case 61, thereby sealing the upper portion of the filter case 61.

In this case, as illustrated in FIG. 1, semicircular grooves may be formed at contact points between the two plate members, respectively, so that a circular hole is formed when the semicircular grooves meet each other and an end portion of the discharge pipe 51 is inserted into the circular hole.

Therefore, since only the filter 62 is replaced after the filter cover 674 is opened, the filter portion 60 is not necessarily replaced, and thus the filter portion 60 is continuously usable if only the filter 62 is intermittently replaced.

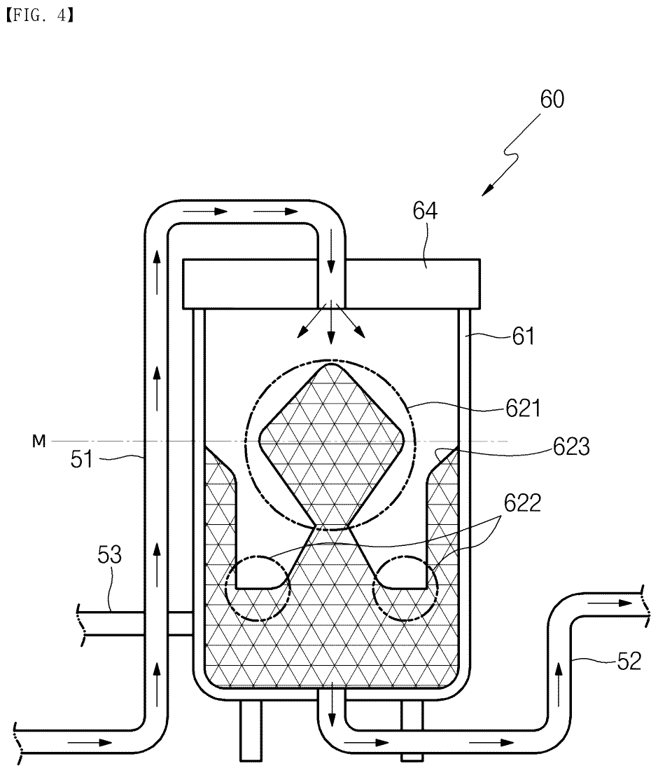

Meanwhile, according to the embodiment of FIG. 4 of the present invention, the filter 62 may have a concavo-convex portion formed on a surface thereof, and the concavo-convex portion has a shape in which a main filtration zone 621 having a center protruding upward, side filtration zones 623 protruding upward from both sides of the concavo-convex portion, and impurity zones 622 recessed between the main filtration zone and the side filtration zone may be continuously formed.

As illustrated in FIG. 4, the main filtration zone 621 may have a shape in which a peak is formed at the center thereof, a slope is formed downward in every direction from the peak such that a horizontal cross-sectional area increases, and the slope may be configured such that the horizontal cross-sectional area decreases at a predetermined point (height M), so that a volume of the impurity zone 622 may be secured to accumulate a large amount of impurities, and a filter surface area for enabling filtration may be sufficiently secured at an upper portion of the main filtration zone 621.

The present invention described above is not limited by the above-described embodiments and the accompanying drawings, and it will be apparent to those skilled in the art to which the present invention that pertains various substitutions, modifications, and changes are possible without departing from the technical spirit of the present invention.

What is claimed is:

1. A water-oil separation type frying device comprising:
a frame;
a frying portion installed on the frame;
a circulation portion configured to circulate water filled in a lower portion of the frying portion;
a filter portion installed at a predetermined position of the circulation portion to remove foreign substances from the water circulated along the circulation portion;
a control portion configured to control the frying portion and the circulation portion; and
a lifting mechanism including a frying plate accommodated in the frying portion so that food that needs to be fried is placed on the frying plate during frying, and a mechanism for lifting up and down the frying plate,
wherein the mechanism for lifting up and down includes a lifting control motor configured to drive the frying plate such that the frying plate is lifted up and down, a power transmission mechanism configured to transmit a driving force of the lifting control motor to the frying plate, a guide rail configured to guide the frying plate such that the frying plate is lifted up and down with respect to the power transmission mechanism, and a lifting control plate for controlling the lifting control motor, and
a power switch, which is provided in the control portion so as to turn on or off power of the control portion, is installed on a front surface of the frame.

2. The water-oil separation type frying device of claim 1, wherein the frying portion includes a frying tank configured to accommodate water and oil and having a drain hole formed in a lower portion thereof, a heating unit configured to transmit thermal energy to an inside of the frying tank; and a heating module configured to control the heating unit to generate the thermal energy,
the heating unit includes a heating wire configured to emit the thermal energy, and
the heating wire is filled with a heating coil or a heating gas.

3. The water-oil separation type frying device of claim 1, wherein the control portion is provided with a control panel for an operation,
the control panel is provided on a side surface of the frame and is spaced apart from the frying portion, thereby preventing a short circuit caused by the water accommodated in the frying portion,
the circulation portion includes a discharge pipe connected to the drain hole to serve as a path for discharging the water in the lower portion of the frying tank, and a circulation pipe which is a path for connecting the discharge pipe and the frying tank so as to supply the water back to the lower portion of the frying tank in a state where the foreign substances are removed from the water discharged along the discharge pipe, and
the filter portion is installed between the discharge pipe and the circulation pipe.

4. The water-oil separation type frying device of claim 3, wherein the filter portion includes a filter case, a filter detachably accommodated in the filter case, and a support installed under the filter case,
the discharge pipe is installed above a location of the filter in the filter case, and the circulation pipe is installed below the location of the filter in the filter case,
water containing scraps discharged from the frying tank enters an inside of the filter case along the discharge pipe so that the scraps are filtered out while passing through the filter, and the water flows out along the circulation pipe and is supplied back to the frying tank,
the filter case has a separate sewage pipe installed at a lower portion of the location of the filter,
the filter case is provided at an upper portion thereof with a filter cover, in which the filter cover includes two plate members which are slidably coupled to each other while facing each other side by side at the upper portion of the filter case, thereby sealing the upper portion of the filter case,
semicircular grooves are formed at contact points between the two plate members, respectively, so that a circular hole is formed when the semicircular grooves meet each other and the discharge pipe is inserted into the circular hole,
so that the filter portion is continuously usable without replacement of the filter portion by replacing only the filter after the filter cover is opened.

5. The water-oil separation type frying device of claim 4, wherein the filter has a concavo-convex portion formed on a surface thereof, and
the concavo-convex portion has a shape in which a main filtration e having a center protruding upward, side filtration zones protruding upward from both sides of the concavo-convex portion, and impurity zones recessed between the main filtration zone and the side filtration zone are continuously formed.

6. The water-oil separation type frying device of claim 5, wherein the main filtration zone has a shape in which a peak is formed at the center thereof, a slope is formed downward in every direction from the peak such that a horizontal cross-sectional area increases, and the slope is configured such that the horizontal cross-sectional area decreases at a predetermined point, so that a volume of the impurity zone is secured to accumulate a large amount of impurities, and a filter surface area for enabling filtration is sufficiently secured at an upper portion of the main filtration zone.
